(19) United States
(12) Patent Application Publication
(10) Pub. No.: US 2016/0315357 A1
(43) Pub. Date: Oct. 27, 2016

(54) DEVICE FOR CONTROLLING ALKALI STORAGE BATTERY

(71) Applicant: TOYOTA JIDOSHA KABUSHIKI KAISHA, Toyota-shi (JP)

(72) Inventor: Tomoya MATSUNAGA, Susono-shi (JP)

(73) Assignee: TOYOTA JIDOSHA KABUSHIKI KAISHA, Toyota-shi (JP)

(21) Appl. No.: 15/133,504

(22) Filed: Apr. 20, 2016

(30) Foreign Application Priority Data
Apr. 22, 2015 (JP) 2015-087865

(51) Int. Cl. H01M 10/42; H01M 4/24; H01M 4/32; B60L 11/18; H01M 4/38; H01M 4/52; H01M 4/62; H01M 10/48; H01M 10/34; H01M 4/66

(52) U.S. Cl. CPC H01M 10/4257; H01M 10/345; H01M 4/242; H01M 4/32; H01M 4/661; H01M 4/38; H01M 4/52; H01M 4/626; H01M 4/622; H01M 10/48; B60L 11/1851; H01M 2004/027

(57) ABSTRACT

Provided is a device for controlling an alkali storage battery including a positive electrode, a negative electrode, and an ion conductor layer that is filled between the positive electrode and the negative electrode. The negative electrode contains a composite alloy that contains a hydrogen storage alloy and a coating layer containing a TiPd phase as a major component, the hydrogen storage alloy has a BCC structure containing Ti and V, a surface of the hydrogen storage alloy is coated with the coating layer, and the TiPd phase contains Ti and Pd at a molar ratio Ti:Pd of 1:1. The device includes a controller. In a case where the voltage of the alkali storage battery is the predetermined voltage or higher, discharging is continued without any change, in a case where the voltage of the alkali storage battery is lower than the predetermined voltage, the discharging is stopped.

### INCORPORATION BY REFERENCE

The disclosure of Japanese Patent Application No, 2015-087865 filed on Apr. 22, 2015 including the specification, drawings and abstract is incorporated herein by reference in its entirety.

### BACKGROUND OF THE INVENTION

1. Field of the Invention

The present invention relates to a device for controlling an alkali storage battery.

2. Description of Related Art

A hydrogen storage alloy is used in, for example, an electrode for an alkali battery. As a technique relating to the hydrogen storage alloy, for example, Japanese Patent Application Publication No. 2004-277862 (JP 2004-277862 A) discloses a method of manufacturing an electrode for a secondary battery, the electrode including: hydrogen storage powder; and a coating layer that is formed on a surface of the hydrogen storage powder and contains at least one of Ni, Pd, and Pt.

In the method disclosed in JP 2004-277862 A, it was found that, when the hydrogen storage alloy, which has the surface coated with Pd, is used in an electrode for an alkali storage battery to charge or discharge a battery, cycle characteristics may deteriorate.

### SUMMARY OF THE INVENTION

The invention provides a device for controlling an alkali storage battery capable of improving cycle characteristics.

As a result of thorough investigation, the present inventors found that, when an alkali storage battery in which a composite alloy is used in a negative electrode is discharged, cycle characteristics of the alkali storage battery can be improved by controlling the voltage of the alkali storage battery not to be lower than 1 V. The composite alloy contains a hydrogen storage alloy and a coating layer containing a TiPd phase as a major component, the hydrogen storage alloy has a BCC structure containing Ti and V, a surface of the hydrogen storage alloy is coated with the coating layer, and the TiPd phase contains Ti and Pd at a molar ratio Ti:Pd of 1:1. The invention has been completed based on the above findings.

According to an aspect of the invention, there is provided a device for controlling an alkali storage battery, the device including: a controller configured to control discharging of the alkali storage battery, the alkali storage battery including a positive electrode; a negative electrode; an ion conductor layer that is filled between the positive electrode and the negative electrode and in which an aqueous alkali solution is used. In the device for controlling an alkali storage battery, the negative electrode contains a composite alloy that contains a hydrogen storage alloy and a coating layer containing a TiPd phase as a major component, the hydrogen storage alloy has a BCC structure containing Ti and V, a surface of the hydrogen storage alloy is coated with the coating layer, the TiPd phase contains Ti and Pd at a molar ratio Ti:Pd of 1:1, the controller is configured to determine whether or not a voltage of the alkali storage battery, which is detected during discharging, is lower than a predetermined voltage, in a case where the voltage of the alkali storage battery is the predetermined voltage or higher, the discharging is continued without any change, in a case where the voltage of the alkali storage battery is lower than the predetermined voltage, the controller is configured to control the alkali storage battery such that the discharging is stopped, and the predetermined voltage is 1 V or higher.

Here, “containing a TiPd phase as a major component, the TiPd phase containing Ti and Pd at a molar ratio Ti:Pd of 1:1” represents that a proportion of the TiPd phase, which contains Ti and Pd at a molar ratio Ti:Pd of 1:1, in the coating layer is 50 mol % or higher. When an alkali storage battery (single cell) in which a composite alloy is used in a negative electrode, is discharged to a battery voltage of lower than 1 V, a side reaction is likely to progress in addition to an intended discharge reaction, and a surface of the composite alloy is modified. The composite alloy contains a hydrogen storage alloy and a coating layer containing a TiPd phase as a major component, the hydrogen storage alloy has a BCC structure containing Ti and V, a surface of the hydrogen storage alloy is coated with the coating layer, and the TiPd phase contains Ti and Pd at a molar ratio Ti:Pd of 1:1. As a result, charging-discharging cycle characteristics deteriorate. Therefore, during the discharging of the alkali storage battery, the battery voltage is detected, the discharging of a battery having a voltage lower than a predetermined voltage is stopped (at this time, “predetermined voltage” is 1 V or higher; hereinafter, the same shall be applied). As a surface, the surface of the composite alloy is not likely to be modified, and thus deterioration in charging-discharging cycle characteristics can be suppressed. As a result, by adopting the above-described configuration, the charging-discharging cycle characteristics of the alkali storage battery can be improved.

In the device for controlling an alkali storage battery, a voltage may be detected per alkali storage battery cell or per module including plural alkali storage battery cells.

In the device for controlling an alkali storage battery, in a case where a voltage of an alkali storage battery cell or a module is a threshold or higher, discharging of the alkali storage battery cell or the module may be continued, and in a case where a voltage of an alkali storage battery cell or a module is lower than the threshold, discharging of the alkali storage battery cell or the module having a voltage lower than the threshold may be stopped.

In the device for controlling an alkali storage battery, a circuit may be changed such that a current flows through a bypass circuit that bypasses alkali storage battery cells having a voltage lower than the threshold or modules having a voltage lower than the threshold.

In the device for controlling an alkali storage battery, the controller may be configured to determine whether or not an output request from a control device for controlling driving of an automobile can be satisfied by discharging alkali storage battery cells other than alkali storage battery cells, which are disconnected from the circuit, or discharging modules other than modules including alkali storage battery cells, which are disconnected from the circuit, without applying a load equal to or higher than a threshold to the alkali storage battery cells or the modules.

In addition, the controller may be configured to determine whether an output value may be set to be equal to or lower than a value requested from the control device for controlling driving of an automobile by determining whether or not the output request from the control device for controlling driving of an automobile can be satisfied.

In the device for controlling an alkali storage battery, based on the number of alkali storage battery cells which are disconnected from the circuit or the number of modules including alkali storage battery cells which are disconnected from the circuit, the controller may be configured to determine whether or not the output request from the control device for controlling driving of an automobile can be satisfied by discharging alkali storage battery cells other than alkali storage battery cells, which are disconnected from the circuit, or discharging modules other than modules including alkali storage battery cells, which are disconnected from the circuit, without applying a load equal to or higher than a predetermined value to the alkali storage battery cells or the module.

According to the invention, a device for controlling an alkali storage battery capable of improving cycle characteristics can be provided.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a diagram showing a device 10 for controlling an alkali storage battery according to the invention;

FIG. 2 is a diagram showing an alkali storage battery 1;

FIG. 3 is a diagram showing a composite alloy 3;

FIG. 4 is a diagram showing a configuration example of controlling the alkali storage battery;

FIG. 5 is a diagram showing another configuration example of controlling the alkali storage battery;

FIGS. 6A and 6B are graphs showing the results of EDX analysis on a sample of Example 1;

FIG. 7 is a graph showing an effect of Pd on discharge behavior;

FIG. 8A is a diagram showing a backscattered electron image obtained by observing the sample of Example 1 with a SEM;

FIG. 8B is a diagram showing a backscattered electron image obtained by observing a sample of Comparative Example 1 with a SEM;

FIG. 8C is a diagram showing a backscattered electron image obtained by observing a sample of Comparative Example 6 with a SEM;

FIG. 9A is a diagram showing sites of the sample of Comparative Example 1 on which EDX analysis was performed;

FIG. 9B is a graph showing the results of EDX analysis on a surface of a particle of the sample of Comparative Example 1; and

FIG. 9C is a graph showing the results of EDX analysis on the inside of the particle of the sample of Comparative Example 1.

### DETAILED DESCRIPTION OF EMBODIMENTS

Hereinafter, the invention will be described with reference to the drawings. In the following description, a method of controlling an alkali storage battery used in an automobile will be described. However, the above-described configuration is an example of the invention, and the invention is not limited to the following embodiment.

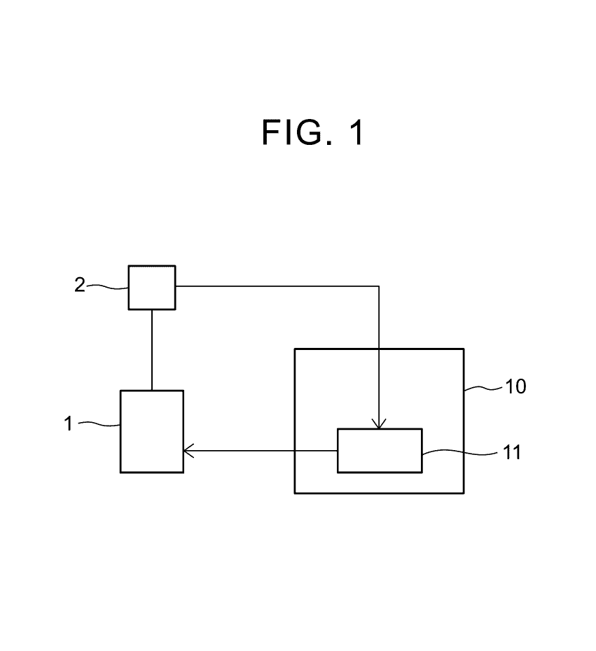

FIG. 1 is a diagram showing a device 10 for controlling an alkali storage battery according to the invention. In FIG. 1, an alkali storage battery 1, a voltmeter 2, and a control device 10 will be schematically shown. As shown in FIG. 1, the control device 10 includes a controller 11. A voltage of the alkali storage battery 1 is measured by the voltmeter 2 during discharging, and the measurement result is sent to the controller 11. The controller 11 which receives the measurement result as described above determines whether or not the voltage of the alkali storage battery 1 is lower than a predetermined voltage. In a case where the voltage is the predetermined voltage or higher, the controller 11 continues discharging of the alkali storage battery 1 without any change. On the other hand, in a case where the voltage is lower than the predetermined voltage, the controller 11 stops discharging of the alkali storage battery 1 having a voltage lower than the predetermined voltage.

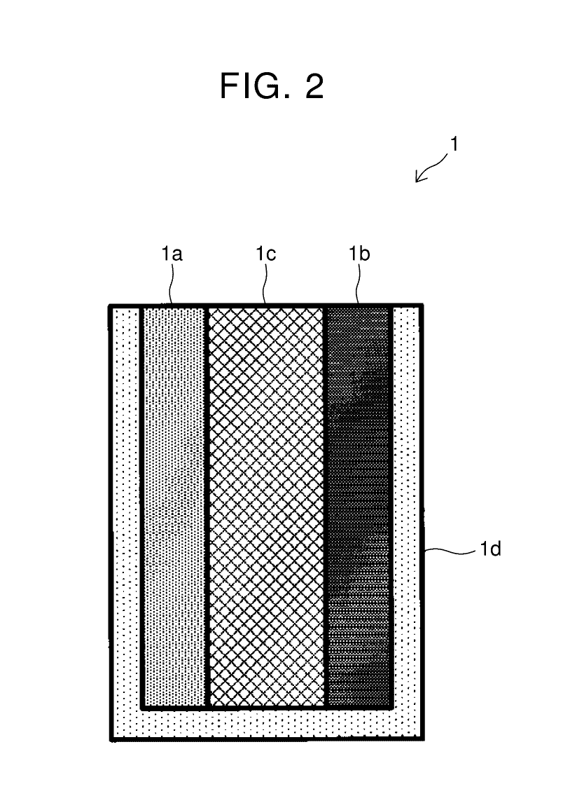

FIG. 2 schematically shows the alkali storage battery 1. As shown in FIG. 2, the alkali storage battery 1 includes a positive electrode 1a, a negative electrode 1b, and an ion conductor layer 1c that is filled between the positive electrode 1a and the negative electrode 1b. The positive electrode 1a, the negative electrode 1b, and the ion conductor layer 1c are accommodated in a case 1d. The negative electrode 1b contains a composite alloy that contains a hydrogen storage alloy and a coating layer containing a TiPd phase as a major component. The hydrogen storage alloy has a BCC structure containing Ti and V. A surface of the hydrogen storage alloy is coated with the coating layer. The TiPd phase contains Ti and Pd at a molar ratio Ti:Pd of 1:1. As the ion conductor layer 1c, a separator impregnated with an aqueous alkali solution is used. The ion conductor layer 1c is in contact with the positive electrode 1a and the negative electrode 1b. During operation of the alkali storage battery 1, ions move between the positive electrode 1a and the negative electrode 1b through the ion conductor layer 1c.

By the controller 11 controlling the discharging of the alkali storage battery 1 having the above-described configuration, the surface of the composite alloy used in the negative electrode 1b is not likely to be modified. Therefore, deterioration in charging-discharging cycle characteristics can be suppressed. As a result, according to the device 10 for controlling an alkali storage battery, the charging-discharging cycle characteristics of the alkali storage battery can be improved.

The positive electrode 1a and the case 1d which are included in the alkali storage battery 1 controlled by the control device 10 according to the invention can be appropriately controlled according to the configuration of the alkali storage battery 1. For example, the alkali storage battery 1 may be a nickel metal hydride battery or an air battery, or may have another configuration. In a case where the alkali storage battery 1 is a nickel metal hydride battery, for example, nickel hydroxide (Ni(OH)₂) can be used in the positive electrode 1a. On the other hand, in a case where the alkali storage battery 1 is an air battery, for example, an oxide having a perovskite structure such as LaNiO₃ can be used in the positive electrode 1a.

As the aqueous alkali solution used in the ion conductor layer 1c, an aqueous alkali solution which can be used in an alkali storage battery can be appropriately used. Examples of the aqueous alkali solution include a potassium hydroxide aqueous solution. As the separator which is impregnated with the aqueous alkali solution and can be used as the ion conductor layer 1c, for example, polypropylene non-woven fabric can be used.

As the case 1d, a case formed of a material, which is not reactive with the aqueous alkali solution used in the ion conductor layer 1e, can be appropriately used. Examples of the material include an acrylic resin.

The negative electrode 1b may further contain other materials as long as it has the above-described composite alloy. Examples of the other materials which may be contained in the negative electrode 1b include: a conductive additive which is used to improve conductivity; and a binder which is used to bind the composite alloy and the conductive additive to each other. As the conductive additive, a conductive material which can withstand a usage environment of the alkali storage battery can be used. For example, metal particles such as Ni particles can be used. As the binder, for example, carboxymethyl cellulose (CMC) or polyvinyl alcohol (PVA) can be used. As a method of preparing the negative electrode 1b using the composite alloy, the conductive additive, and the binder, for example, a method may be used including: weighing the composite alloy, the conductive additive, and the binder at a predetermined weight ratio; kneading the components to prepare a paste-like composition; applying the composition to a porous conductive member; drying the composition; and pressing the composition at a predetermined pressure.

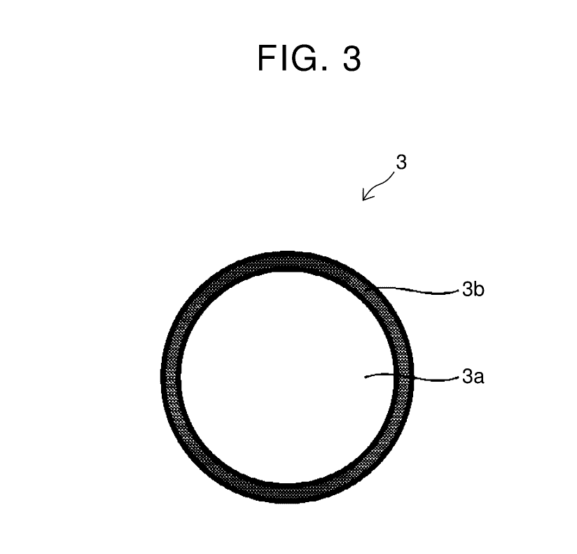

FIG. 3 is a diagram showing a configuration of a composite alloy 3. FIG 3 schematically shows the composite alloy 3. The composite alloy 3 shown in FIG. 3 contains a hydrogen storage alloy 3a having a BCC structure, which contains Ti and V, and a coating layer 3b with which a surface of the hydrogen storage alloy 3a is coated (the layer 3b containing a TiPd phase as a major component, the TiPd phase containing Ti and Pd at a molar ratio Ti:Pd of 1:1). For example, the composite alloy 3 can be manufactured through the following steps of: depositing pure Pd having a purity of 80% or higher to the surface of the hydrogen storage alloy 3a which has the BCC structure containing Ti and V; and performing a heat treatment at a predetermined temperature. In the invention, a proportion of a portion, which is coated with the coating layer 3b, in the entire area of the surface of the composite alloy 3 is not particularly limited. At least a portion of the surface of the composite alloy 3 only has to be coated with the coating layer 3b. However, from the viewpoint of obtaining the alkali storage battery 1 in which the discharge capacity can be easily improved, it is preferable that the entire area of the surface of the composite alloy 3 is coated with the coating layer 3b.

In the invention, the thickness of the coating layer 3b is not particularly limited. The thickness of the coating layer 3b is not particularly limited as long as the surface of the composite alloy 3 is coated therewith. For example, it is presumed that, even when the thickness of the coating layer 3b is about, several nanometers, the discharge capacity can be improved. Likewise, it is presumed that, even when the thickness of the coating layer is great, the discharge capacity can be improved. However, when the thickness is excessively great, the capacity per weight is reduced. Therefore, from the viewpoint of preventing a significant reduction in the capacity per weight, the thickness of the coating layer 3b is preferably 10 μm or less.

During the manufacturing of the alkali storage battery 1, the negative electrode 1b can be manufactured using, for example, the above-described method. On the other hand, the positive electrode 1a can be manufactured using, for example, a method including: weighing nickel hydroxide, cobalt oxide, and a binder at a predetermined weight ratio; kneading the components to prepare a paste-like composition; applying the composition to a porous conductive member; drying the composition; and pressing the composition at a predetermined pressure. Next, the aqueous alkali solution whose concentration is adjusted to a predetermined value is put into the case 1d. Further, the positive electrode 1a and the negative electrode 1b are put into the case 1d into which the aqueous alkali solution is put. As a result, the alkali storage battery 1 can be manufactured.

In the present invention, the configuration of the voltmeter 2 is not particularly limited as long as it can measure the voltage of the alkali storage battery 1 and can send the measure result to the controller 11.

As described above, in the invention, in a case where the controller 11 determines that the voltage is a predetermined voltage or higher, the controller 11 continues the discharging of the alkali storage battery 1 without any change. In a case where the voltage is lower than the predetermined voltage, the controller 11 stops the discharging of the alkali storage battery 1 having a voltage lower than the predetermined voltage. The configuration of the device for controlling an alkali storage battery according to the invention is not particularly limited as long as it includes the controller which can perform the above-described control. Specific configuration examples of controlling the alkali storage battery using the device 10 for controlling an alkali storage battery according to the invention will be described below.

### 1. First Embodiment

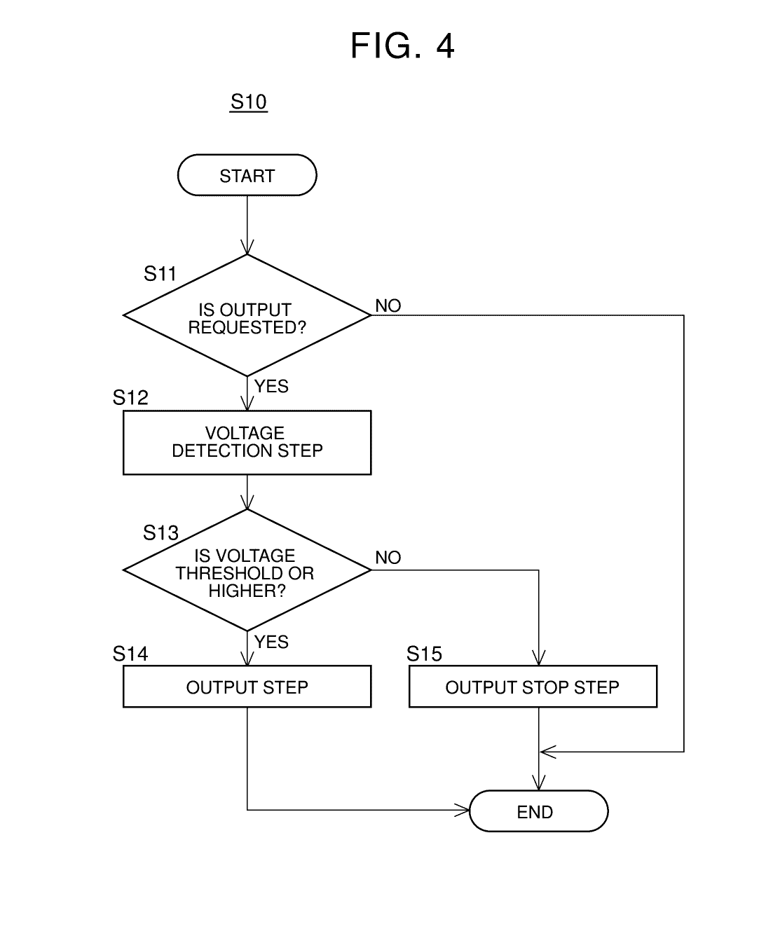

FIG. 4 is a diagram showing a method S10 of controlling the alkali storage battery according to a first embodiment. The control configuration example will be described with reference to FIG. 4. The control method S10 shown in FIG. 4 includes an output request verification step S11, a voltage detection step S12, a voltage determination step S13, an output step S14, and an output stop step S15.

In the output request verification step S11 (hereinafter, also referred to as “S11”), whether or not a predetermined output is requested from the control device for controlling the driving of an automobile to the alkali storage battery is verified. The control method S10 is performed only when the alkali storage battery is used. Therefore, in a case where the output request is not sent, the subsequent steps are not performed. Only in a case where the output request is sent, the process proceeds to the next step.

In the voltage detection step S12 (hereinafter, also referred to as “S12”), the voltage of the alkali storage battery is detected after S11. In S12, the voltage of the alkali storage battery may be detected per cell (single cell) or per module including plural alkali storage battery cells. In general, in plural alkali storage battery cells mounted on an automobile, there may be a difference in discharge performance depending on, for example, the temperature distribution in the vehicle. In this case, the alkali storage battery cells can be classified into plural groups depending on the discharge performance. In this way, in a case where the plural alkali storage battery cells can be classified into plural groups, S12 may be a step of detecting the voltages of some of the alkali storage battery cells or some of the modules which represent the respective groups.

In the voltage determination step S13 (hereinafter, also referred to as “S13”), the controller 11 determines whether or not the voltage detected in S12 is a threshold or higher. In a case where the voltage of the alkali storage battery is detected per cell in S12, the controller 11 determines whether or not the voltage detected in S12 is lower than a predetermined voltage in S13. In a case where the voltage is the predetermined voltage or higher (for example, 1 V or higher), the output step S14 is performed after S13. In a case where the voltage is lower than the predetermined voltage (for example, lower than 1 V), the output stop step S15 is performed after S13. On the other hand, in a case where the voltage of the alkali storage battery is detected per module in S12, when the number of alkali storage battery cells included in the module whose voltage is detected is represented by n (n represents an integer of 2 or more), the controller 11 determines whether or not the voltage detected in S12 is lower than a value, which is n times (for example, n V) the predetermined voltage, in S13. In a case where the voltage is n V or higher, the output step S14 is performed after S13. In a case where the voltage is lower than n V, the output stop step S15 is performed after S13.

The output step S14 (hereinafter, also referred to as “S14”) is performed in a case where it is determined in S13 that the voltage is the threshold or higher. Further, in S14, the alkali storage battery is discharged without any change such that an output requested from the control device for controlling the driving of an automobile is obtained. In a case where it is determined in S13 that the voltage is the threshold or higher, as described below, the surface of the composite alloy which is used in the negative electrode of the alkali storage battery is not likely to be modified, and thus charging-discharging cycle characteristics are not likely to deteriorate. Therefore, in a case where it is determined in S13 that the voltage is the threshold or higher, the alkali storage battery is discharged without any change such that an output requested from the control device for controlling the driving of an automobile is obtained.

The output stop step S15 (hereinafter, also referred to as “S15”) is performed in a case where it is determined in S13 that the voltage is lower than the threshold. Further, in S15, the discharging of the alkali storage battery is stopped. In a case where it is determined in S13 that the voltage is lower than the threshold, as described below, the surface of the composite alloy which is used in the negative electrode of the alkali storage battery is modified, and thus charging-discharging cycle characteristics are likely to deteriorate. Therefore, in a case where it is determined in S13 that the voltage is lower than the threshold, the discharging of the alkali storage battery is stopped in S15 in order to suppress deterioration in charging-discharging cycle characteristics.

In the control method S10 including S11 to S15, in a case where the voltage is the threshold or higher, the discharging of the alkali storage battery is continued without any change. Further, in a case where the voltage is lower than the threshold, the discharging of the alkali storage battery is stopped. When the discharging of the alkali storage battery having a voltage lower than the threshold in which the composite alloy is used is continued, charging-discharging cycle characteristics deteriorate. Therefore, according to the invention, charging-discharging cycle characteristics can be improved as compared to a case where the discharging of the alkali storage battery having a voltage lower than the threshold, in which the composite alloy is used, is continued.

### 2. Second Embodiment

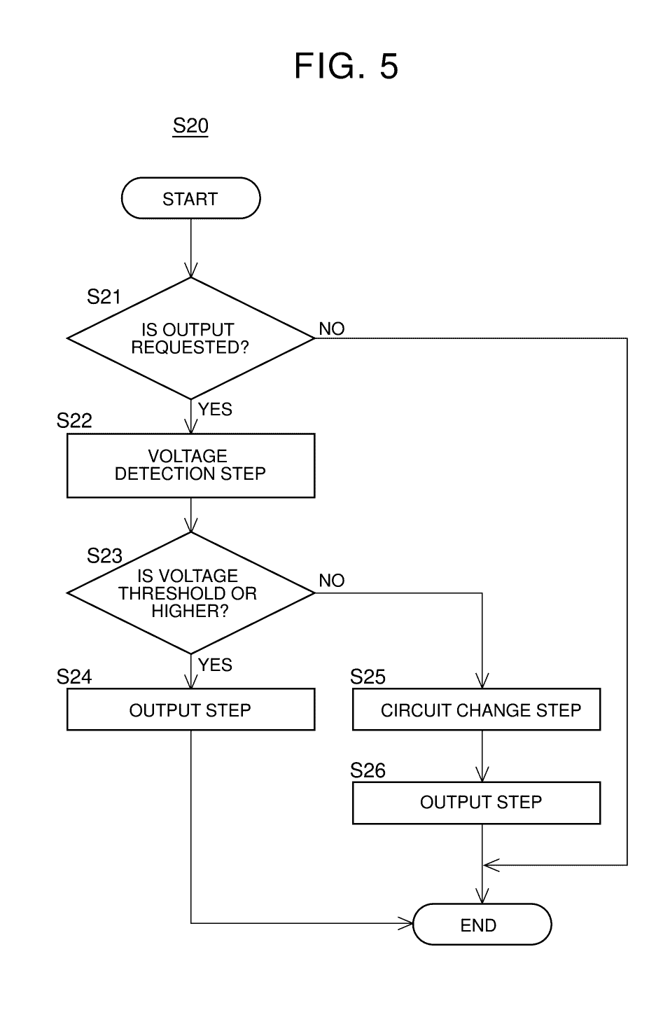

FIG. 5 is a diagram showing a method S20 of controlling the alkali storage battery according to a second embodiment. The control configuration example will be described with reference to FIG. 5. The control method S20 shown in FIG. 5 includes an output request verification step S21, a voltage detection step S22, a voltage determination step S23, an output step S24, a circuit change step S25, and an output step S26.

In the output request verification step S21 (hereinafter, also referred to as “S21”), whether or not a predetermined output is requested from the control device for controlling the driving of an automobile to the alkali storage battery is verified. The control method S20 is performed only when the alkali storage battery is used. Therefore, in a case where the output request is not sent, the subsequent steps are not performed. Only in a case where the output request is sent, the process proceeds to the next step.

In the voltage detection step S22 (hereinafter, also referred to as “S22”), the voltage of the alkali storage battery is detected after S21. Since S22 is the same as S12 described above, the description thereof will not be repeated.

In the voltage determination step S23 (hereinafter, also referred to as “S23”), the controller 11 determines whether or not the voltage detected in S22 is a threshold or higher. Since S23 is the same as S13 described above, the description thereof will not be repeated.

The output step S24 (hereinafter, also referred to as “S24”) is performed in a case where it is determined in S23 that the voltage is the threshold or higher. Further, in S24, the alkali storage battery is discharged without any change such that an output requested from the control device for controlling the driving of an automobile is obtained. In a case where it is determined in S23 that the voltage is the threshold or higher, as described below, the surface of the composite alloy which is used in the negative electrode of the alkali storage battery is not likely to be modified, and thus charging-discharging cycle characteristics are not likely to deteriorate. Therefore, in a case where it is determined in S23 that the voltage is the threshold or higher, the alkali storage battery is discharged without any change such that an output requested from the control device for controlling the driving of an automobile is obtained.

The circuit change step S25 (hereinafter, also referred to as “S25”) is performed in a case where it is determined in S23 that the voltage is lower than the threshold. Further, in S23, a circuit is changed such that a current flows through a bypass circuit that bypasses alkali storage battery cells or modules having a voltage lower than the threshold. In order to perform S25, an alkali storage battery system used in the control method S20 is configured such that: in a case where the voltage of an alkali storage battery cell (or a module) is a threshold or higher, a current flows the alkali storage battery cell (or the module); and in a case where the voltage of an alkali storage battery cell (or a module) is lower than the threshold, a current flows to the bypass circuit, which bypasses alkali storage battery cells (or the modules) having a voltage lower than the threshold, by disconnecting the alkali storage battery cells (or the modules) from the circuit. In a case where it is determined in S23 that the voltage of an alkali storage battery cell (or a module) is lower than the threshold, in S25, the discharging of the alkali storage battery is stopped by preventing a current from flowing to the alkali storage battery cell (or the module) having a voltage lower than the threshold. As a result, the modification of the surface of the composite alloy, which is used in the negative electrode of the alkali storage battery, can be suppressed, and thus the charging-discharging cycle characteristics of the alkali storage battery can be improved as compared to a case where the modification is not suppressed.

The output step S26 (hereinafter, also referred to as “S26”) is performed after S25. Further, in S26, the alkali storage battery is discharged such that an output requested from the control device for controlling the driving of an automobile is obtained or such that an output requested from the control device for controlling the driving of an automobile is suppressed. In S26, the control device determines whether an output value is set to be equal to or lower than a value requested from the control device for controlling the driving of an automobile. During this determination, the control device determines whether or not an output request from the control device for controlling the driving of an automobile can be satisfied, for example, by discharging alkali storage battery cells (or modules) other than the alkali storage battery cells (or the modules), which are disconnected from the circuit in S25, without applying an excessive load (or having a predetermined value or higher) to the alkali storage battery cells (or the modules). The control device determines whether or not the above-described output request can be satisfied without applying an excessive load (or having a predetermined value or higher) based on the number of alkali storage battery cells (or modules) disconnected from the circuit. In a case where it is determined that an output value is set to be lower than a value requested from the control device, a difference between the values can be determined in consideration of an output value at which the alkali storage battery connected to the circuit is not discharged excessively (or to be a predetermined value or higher).

In the control method S20 including S21 to S26, in a case where the voltage of an alkali storage battery cell (or a module) is a threshold or higher, the discharging of the alkali storage battery cell (or the module) is continued without any change; and in a case where a voltage of an alkali storage battery cell (or a module) is lower than the threshold, discharging of the alkali storage battery cell (or the module) having a voltage lower than the threshold is stopped, and only the alkali storage battery cell (or the module) having a voltage equal to or higher than the threshold is discharged. When the discharging of the alkali storage battery cell (or the module) having a voltage lower than the threshold in which the composite alloy is used is continued, charging-discharging cycle characteristics deteriorate. Therefore, according to the invention, charging-discharging cycle characteristics can be improved as compared to a case where the discharging of the alkali storage battery cell (or the module) having a voltage lower than the threshold, in which the composite alloy is used, is continued without any change.

As described above, as compared to the control method S10, the control method S20 is a method for maximizing the use of the alkali storage battery cell (or the module) having a voltage equal to or higher than the threshold. Therefore, according to the control method S20, a usable range of the alkali storage battery can be easily increased. On the other hand, in an alkali storage battery system to which the control method S10 is applied, the system configuration and the control thereof are simpler than those of an alkali storage battery system to which the control method S20 is applied.

By showing the results of investigating a relationship between a discharge stop voltage and the compositions of a hydrogen storage alloy and a coating layer formed on a surface of the hydrogen storage alloy, the reason why whether or not to stop discharging is determined depending on whether or not the battery voltage is lower than a predetermined voltage in the invention will be described below.

( 1) Preparation of Alkali Storage Battery

### <Preparation of Alloy Material>

Pure Ti (purity: 99.9%, manufactured by Kojundo Chemical Laboratory Co., Ltd), pure Cr (purity: 99.9%, manufactured by Kojundo Chemical Laboratory Co., Ltd), pure V (purity: 99.9%, manufactured by Kojundo Chemical Laboratory Co., Ltd), pure Ni (purity: 99.9%, manufactured by Kojundo Chemical Laboratory Co., Ltd), and pure Pd (purity: 99.9%, manufactured by Kojundo Chemical Laboratory Co., Ltd) were appropriately melted by arc melting. As a result, (a) a TiCrV alloy having a BCC structure in which a composition ratio (molar ratio) Ti:Cr:V was 20:10:70, (b) a TiCrVPd alloy having a BCC structure in which a composition ratio (molar ratio) Ti:Cr:V:Pd was 26:8:56:10, or (c) a TiCrVNi alloy having a BCC structure in which a composition ratio (molar ratio) Ti:Cr:V:Ni was 26:8:56:10 was prepared. Next, in order to remove gas adsorbed on a surface of the prepared alloy, vacuuming is performed at 250° C. under a reduced pressure of 1 Pa or lower for 2 hours. Next, in order to easily pulverize the alloy, hydrotreating was performed. The hydrotreating includes: a hydrogenation step of applying hydrogen gas at a pressure of 30 MPa at normal temperature for hydrogenation; and a discharge step of reducing the pressure to 1 Pa or lower to discharge hydrogen after the hydrogenation step. The hydrogenation step and the discharge step were repeated twice (after a first cycle of the hydrogenation step and the discharge step was performed, a second cycle of the hydrogenation step and the discharge step was performed). A sample on which the hydrotreating was performed (on which the hydrogenation step and the discharge step were performed twice) was classified while being mechanically pulverized. As a result, hydrogen storage alloy powder having a particle size of 150 μm to 300 μm was obtained.

<Coating Treatment on Surface of Hydrogen Storage Alloy Powder>

A coating layer of pure Pd or pure Ni was formed on a surface of the TiCrV alloy through sputtering by using pure Pd (purity: 99 mol % or higher) or pure Ni (purity: 99 mol % or higher) as a target. In order to form the coating layer as uniformly as possible on the surface of the TiCrV alloy, the hydrogen storage alloy powder was coated while being uniformly stirred using a device having a structure in which a cylindrical drum rotates in a portion containing the hydrogen storage alloy powder. As a result, a coating layer having a weight ratio of 0.18 wt % with respect to the hydrogen storage alloy powder was formed.

<Heat Treatment>

A heat treatment was performed on the hydrogen storage alloy powder on which the coating layer was formed. First, 5 g of the powder was put into an alumina pot, and this pot was disposed in an electric furnace. Next, using a rotary pump, the internal pressure of the electric furnace was reduced to 1 Pa or lower, and then the temperature thereof was increased to 690° C. at a rate of 1° C./min. After reaching 690° C., the temperature was maintained at 690° C. for 2 hours. Next, an output of the electric furnace for heating is stopped. While maintaining the above-described pressure after the pressure reduction, the electric furnace was cooled such that the internal temperature thereof was 50° C. or lower. After confirming that the internal temperature of the electric furnace was 50° C. or lower, air was introduced into the electric furnace to return the internal pressure of the electric furnace to the atmospheric pressure. Next, the sample was extracted from the electric furnace.

<Preparation of Electrode (Negative Electrode) for Alkali Storage Battery>

The TiCrVPd alloy, the TiCrVNi alloy, or the sample extracted from the electric furnace (hereinafter, these components will be collectively referred to as “hydrogen storage alloy particles”); a conductive additive of Ni (manufactured by Fukuda Metal foil&Powder Co., Ltd.); and two kinds of binders (carboxymethyl cellulose (CMC, manufactured by DKS Co., Ltd.) and polyvinyl alcohol (PVA, manufactured by Wako Pure Chemical Industries Ltd.)) were added such that a weight ratio (hydrogen storage alloy particle:conductive additive:CMC:PVA) thereof was 49:49:1:1, and then were kneaded with each other. As a result, a paste-like composition was prepared. This paste-like composition was applied to porous nickel (manufactured by Sumitomo Electric Toyama Co., Ltd.), was dried at 80° C., and was roll-pressed at 490 MPa. As a result, an electrode (negative electrode) for an alkali storage battery was prepared.

<Preparation of Alkali Storage Battery>

Nickel hydroxide (Ni(OH)₂, manufactured by Tanaka Chemical Corporation), cobalt oxide (CoO, manufactured by Sigma-Aldrich Co., LLC.), and two kinds of binders (carboxymethyl cellulose (CMC, manufactured by DKS Co., Ltd.) and polyvinyl alcohol (PVA, manufactured by Wako Pure Chemical Industries Ltd.)) were added such that a weight ratio (Ni(OH)₂:CoO:CMC:PVA) thereof was 88:10:1:1, and were kneaded with each other. As a result, a paste-like composition was prepared. This paste-like composition was applied to porous nickel (manufactured by Sumitomo Electric Toyama Co., Ltd.), was dried at 80° C., and was roll-pressed at 490 MPa. As a result, a positive electrode was prepared. In order to prepare an electrolytic solution, a reagent KOH (manufactured by Nacalai Tesque Inc.) was mixed with pure water to adjust the concentration of KOH to 7.15 mol/L. 90 ml of the electrolytic solution was put into an acrylic case, and an alkali storage battery was prepared using the prepared electrode for an alkali storage battery and the positive electrode.

<Charging Test>

Using a charging-discharging cycle tester VMP 3 (manufactured by Bio-Logic Science Instruments SAS), a charging-discharging test was performed at a battery evaluation environment temperature of 25° C. and a current rate of 50 mA/g to obtain the discharge capacity after initial charging and discharging and the discharge capacity after 20 cycles of charging and discharging. At this time, the discharge end voltage was 0.9 V or 1.0 V. A capacity retention (%) was calculated from “100×Discharge Capacity after 20 Cycles of Charging and Discharging×Discharge Capacity after Initial Charging and Discharging”. The obtained results are shown in Table 1 together with the composition of the hydrogen storage alloy particles.

TABLE 1

| | | Discharge | | Capacity | Capac- |
|---|---|---|---|---|---|
| | | End | Initial | after 20 | ity |
| | | Voltage | Capacity | Cycles | Reten- |
| | Sample | (V) | (mAh/g) | (mAh/g) | tion |
| Example | TiCrV | 1.0 | 479 | 467 | 97% |
| 1 | Alloy + Pd | | | | |
| | Coating | | | | |
| Example | TiCrVPd | 1.0 | 471 | 456 | 97% |
| 2 | Alloy | | | | |
| Compar- | TiCrV | 0.9 | 533 | 238 | 45% |
| ative | Alloy + Pd | | | | |
| Example | Coating | | | | |
| 1 | | | | | |
| Compar- | TiCrVPd | 0.9 | 501 | 267 | 53% |
| ative | Alloy | | | | |
| Example | | | | | |
| 2 | | | | | |
| Compar- | TiCrV | 1.0 | 313 | 304 | 97% |
| ative | Alloy + Ni | | | | |
| Example | Coating | | | | |
| 3 | | | | | |
| Compar- | TiCrVNi | 1.0 | 357 | 350 | 98% |
| ative | Alloy | | | | |
| Example | | | | | |
| 4 | | | | | |
| Compar- | TiCrV | 0.9 | 318 | 305 | 96% |
| ative | Alloy + Ni | | | | |
| Example | Coating | | | | |
| 5 | | | | | |
| Compar- | TiCrVNi | 0.9 | 361 | 349 | 97% |
| ative | Alloy | | | | |
| Example | | | | | |
| 6 | | | | | |

The results of Examples 1 and 2 the results of Comparative Examples 1 and 2 were compared to each other in which the sample containing Pd was used. The results do not depend on whether a sample, in which the coating layer of Pd was formed on the surface of the hydrogen storage alloy, or a sample, in which the hydrogen storage alloy containing Pd was used, was adopted. In Examples 1 and 2 in which the discharge end voltage was 1.0 V, the capacity retention was 97%. On the other hand, in Comparative examples 1 and 2 in which the discharge end voltage was 0.9 V, the capacity retention significantly decreased to about 50% (Comparative Example 1: 45%, Comparative Example 2: 53%). Here, as described below regarding the results of analyzing the sample of Example 1 as an example, in the samples of Examples 1 and 2, the surface of the hydrogen storage alloy was coated with a coating layer containing a TiPd phase as a major component, the TiPd phase containing Ti and Pd at a molar ratio Ti:Pd of 1:1. Based on the above results, the following points can be seen regarding an alkali storage battery in which a composite alloy is used in a negative electrode, the composite alloy contains a hydrogen storage alloy and a coating layer containing a TiPd phase as a major component, the hydrogen storage alloy has a BCC structure containing Ti and V, a surface of the hydrogen storage alloy is coated with the coating layer, and the TiPd phase contains Ti and Pd at a molar ratio Ti:Pd of 1:1. When the discharge end voltage is 0.9 V, charging-discharging cycle characteristics deteriorate; however, when the discharge end voltage is 1.0 V, charging-discharging cycle characteristics can be improved. On the other hand, in Comparative Examples 3 to 6 in which the sample containing no Pd was used, irrespective of whether the discharge end voltage was 0.9 V or 1.0 V, the capacity retention was the same, and charging-discharging cycle characteristics did not substantially change.

<Composition Analysis of Coating Layer>

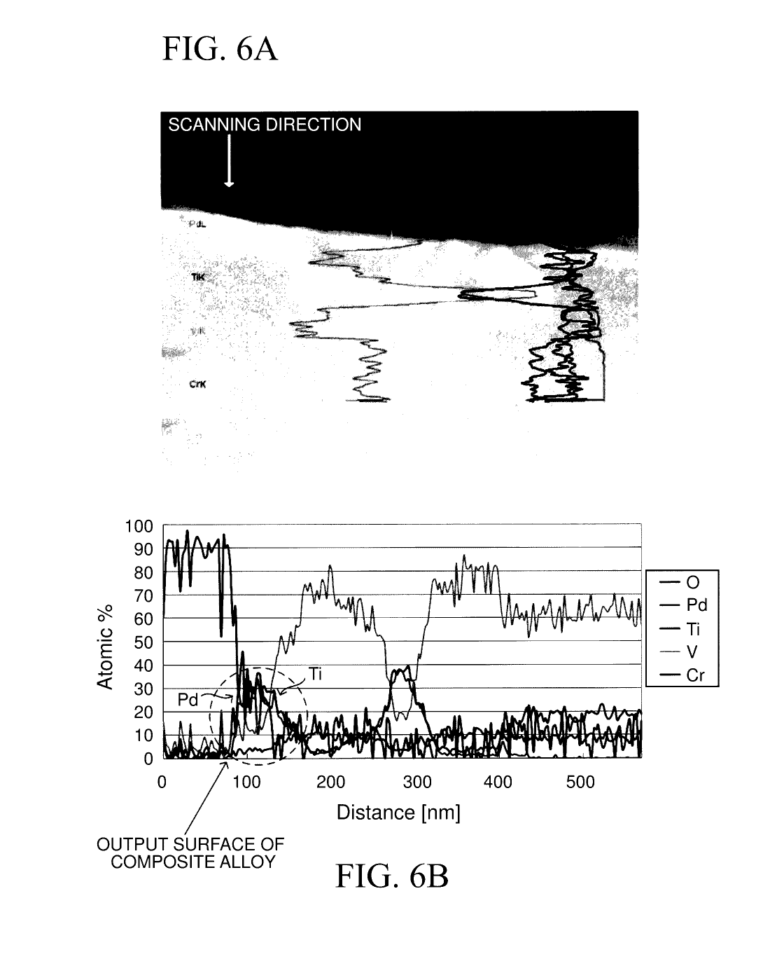

The sample of Example 1 (the sample on which the heat treatment was performed after forming the coating layer of Pd on the surface of the TiCrV alloy; hereinafter, the same shall be applied) was embedded with a resin and then was processed into a slice having a thickness of about 100 nm with a focused ion beam (FIB). A surface state was investigated by analyzing the slice with a scanning transmission electron microscope (HD-2700, manufactured by Hitachi High-Technologies Corporation) and an energy dispersive X-ray spectrometer (EDX; Genesis, manufactured by EDAX Inc.). The results of analyzing the sample of Example 1 are shown in FIGS. 6A and 6 B.

As a result of EDX line analysis shown in FIGS. 6A and 6B, it was able to be verified that the alloy (TiPd phase) containing Ti and Pd at a molar ratio Ti:Pd of 1:1 was present on the outermost surface of the sample of Example 1. It is presumed that the TiPd phase was formed by binding between Ti contained in the hydrogen storage alloy and Pd attached to the surface of the hydrogen storage alloy powder. According to the investigation by the present inventors, the alloy (TiPd phase) containing Ti and Pd at a molar ratio Ti:Pd of 1:1 was also present on the surface of the sample of Example 2.

<Evaluation of Effect of Pd on Discharge Behavior>

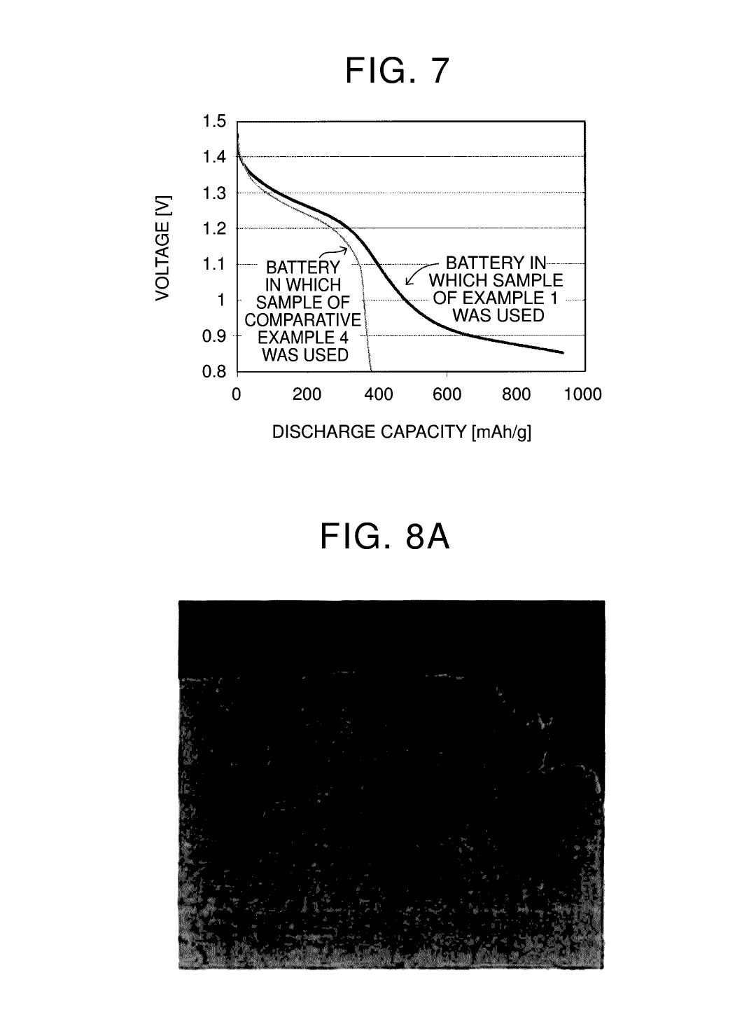

An alkali storage battery in which the sample of Example 1 was used and an alkali storage battery in which the sample of Comparative Example 4 was used were charged at a current rate of 50 mA/g and then were discharged at a current rate of 10 mA/g. Discharging was continued until the negative electrode potential was higher than discharge end conditions shown in Table 1, and the results thereof are shown in FIG. 7.

As shown in FIG. 7, in the alkali storage battery in which the sample of Comparative Example 4 containing no Pd was used, when a discharge reaction caused by hydrogen evolution from the hydrogen storage alloy active material ended (when the discharge capacity was about 400 mAh/g), the battery voltage rapidly decreased, and the current did not substantially flow. On the other hand, in the alkali storage battery in which the sample of Example 1 containing Pd was used, one more stage of a discharge current curve was verified in a region where the battery voltage was lower than 1.0 V. It is presumed that the one more stage of discharge current curve is generated by the progress of a side reaction different from the discharge reaction. The reason why the capacity retention significantly decreased in Comparative Examples 1 and 2 where the discharge end voltage was 0.9 V is presumed to be that the side reaction progressed. On the other hand, it is presumed that, in a case where the hydrogen storage alloy containing no Pd was used, the side reaction did not progress; therefore, the capacity retention was not likely to decrease.

<Investigation Relating to Side Reaction>

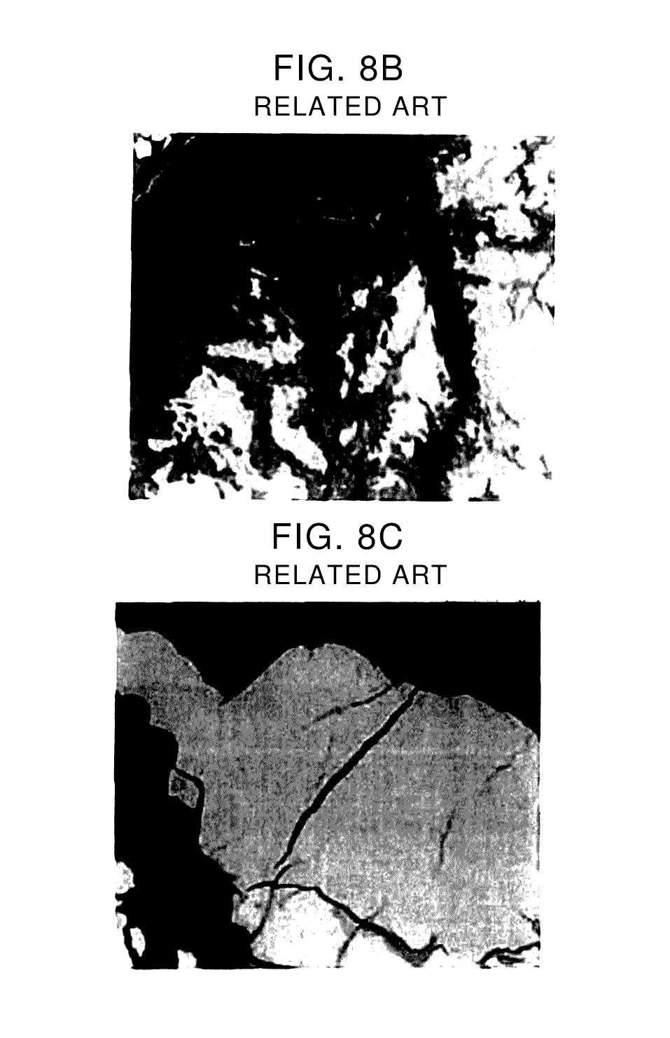

In order to investigate the side reaction in more detail, using a scanning electron microscope (ULTRA55, manufactured by Zeiss), morphological observation was performed on the samples of Example 1 and Comparative Examples 1 and 6 after 20 cycles of the charging-discharge test. The results (backscattered electron images obtained by SEM observation) are shown in FIGS. 8A to 8C. FIG. 8A is a backscattered electron image showing the sample of Example 1. FIG. 8B is a backscattered electron image showing the sample of Comparative Example 1. FIG. 8C is a backscattered electron image showing the sample of Comparative Example 6. The magnification in FIGS. 8A to 8C was 5000 times.

In the backscattered electron images shown in FIGS. 8A to 8C, the contrast values were the same, Therefore, it is presumed that the sample of Example 1 and the sample of Comparative Example 6 have a substantially uniform composition in a particle. On the other hand, in the backscattered electron image shown in FIG. 8B, light and shade was observed in the surface and the inside of a particle. In the backscattered electron image, a deep-color portion shows a lower atomic weight than in a light-color portion. That is, in the sample of Comparative Example 1, the composition of the surface of the particle was different from that of the inside of the particle.

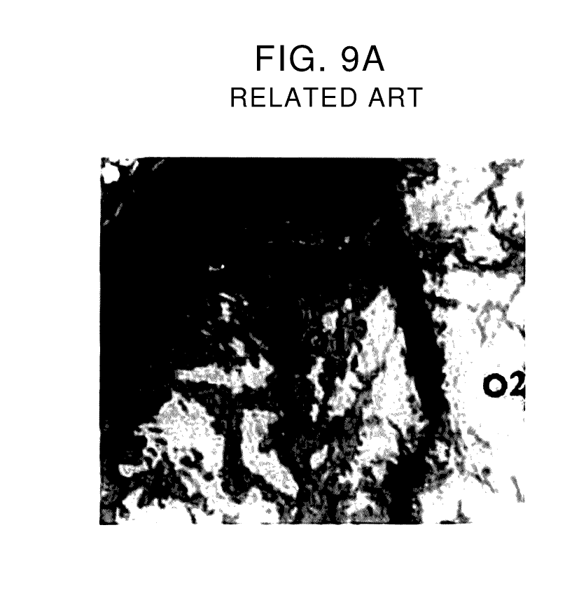

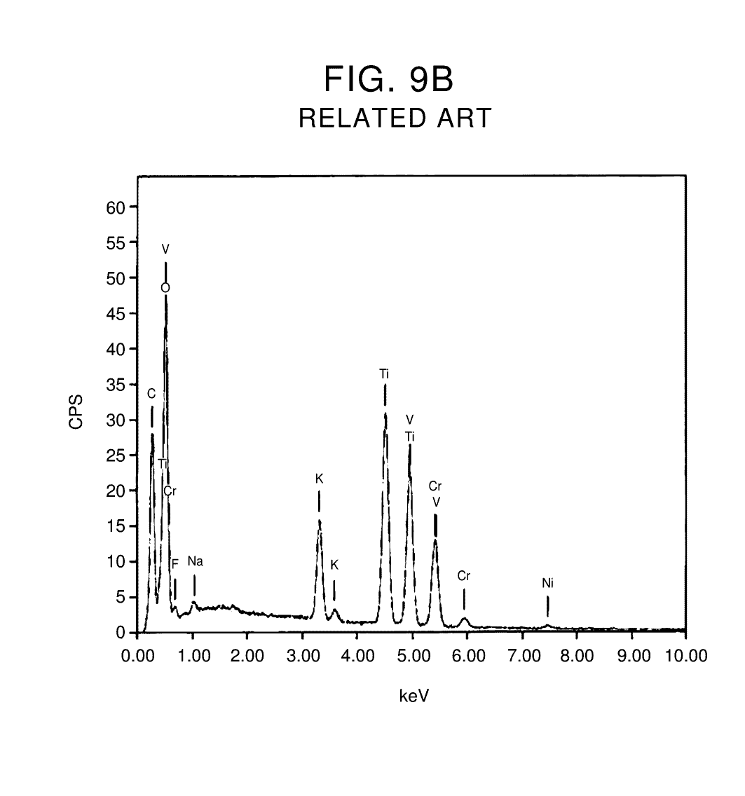

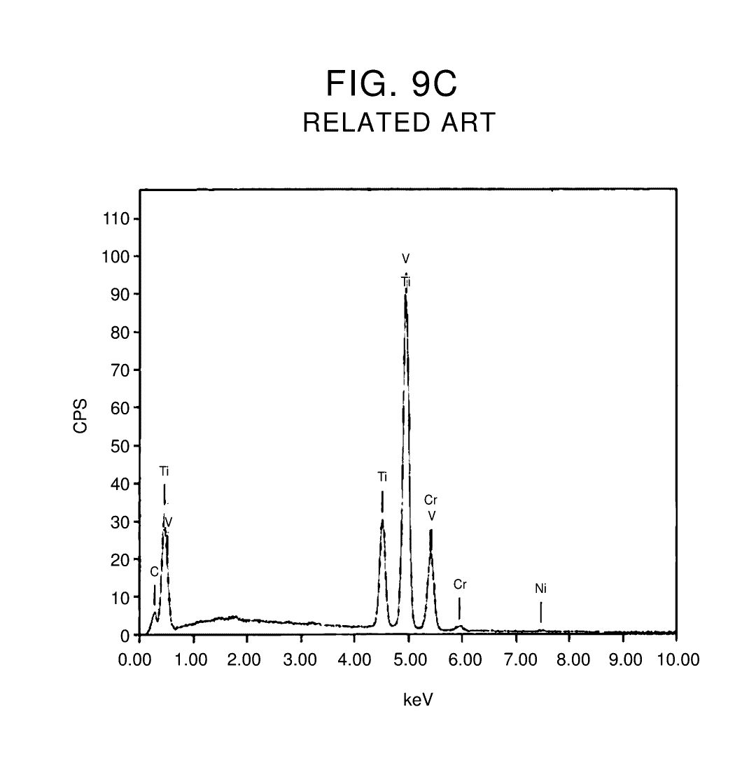

The deep-color portion and the light-color portion shown in FIG. 8B were analyzed using an energy dispersive X-ray spectrometer (EDX; Genesis, manufactured by EDAX Inc.). FIG. 9A shows actually analyzed sites. FIG. 9B shows the result of EDX analysis on a site indicated by “1” in FIG. 9A. FIG. 9C shows the result of EDX analysis on a site indicated by “2” in FIG. 9A. In FIG. 9B showing the results of analyzing the surface of the particle, the peak height of Ti near 4.5 keV was higher than that of VTi near 5.0 keV. On the other hand, in FIG. 9C showing the results of analyzing the surface of the particle, the peak height of Ti near 5.0 keV was higher than that of VTi near 4.5 keV. It was found from the result that, in the sample of Comparative Example 1, the surface of the particle had a lower vanadium concentration than the inside of the particle. A peak of O was found near 0.5 keV in FIG. 9B but was not found in FIG. 9C. It was found from the result that, in the sample of Comparative Example 1, the surface of the particle had a higher oxygen concentration than the inside of the particle. The above results implies that, due to the charging-discharging cycles, the alloy on the surface of the sample of Comparative Example 1 was oxidized first or vanadium was partially eluted thereto.

It is presumed from the results shown in FIGS. 8A to 9C that the side reaction, which was verified in the region shown in FIG. 7 where the battery voltage was lower than 1.0 V, was the oxidation of the hydrogen storage alloy and/or the elution of vanadium. It is presumed that the side reaction did not occur in Example 1 and Comparative Example 6 but progressed significantly under conditions of Comparative Example 1. The reason why satisfactory charging-discharging cycle characteristics were not obtained in Comparative Examples 1 and 2 is presumed to be that, since the surface of the hydrogen storage alloy was modified by the side reaction, the initial reaction activity was not able to be obtained.

What is claimed is:

1. A device for controlling an alkali storage battery, the device comprising:
a controller configured to control discharging of the alkali storage battery, wherein
the alkali storage battery includes a positive electrode, a negative electrode, an ion conductor layer that is filled between the positive electrode and the negative electrode and in which an aqueous alkali solution is used,
the negative electrode contains a composite alloy that contains a hydrogen storage alloy and a coating layer containing a TiPd phase as a major component,
the hydrogen storage alloy has a BCC structure containing Ti and V,
a surface of the hydrogen storage alloy is coated with the coating layer,
the TiPd phase contains Ti and Pd at a molar ratio Ti:Pd of 1:1
the controller is configured to determine whether or not a voltage of the alkali storage battery, which is detected during discharging, is lower than a predetermined voltage,
in a case where the voltage of the alkali storage battery is the predetermined voltage or higher, the discharging is continued without any change,
in a case where the voltage of the alkali storage battery is lower than the predetermined voltage, the controller is configured to control the alkali storage battery such that the discharging is stopped, and
the predetermined voltage is 1 V or higher.

2. The device according to claim 1, wherein
a proportion of the TiPd phase, which contains Ti and Pd at a molar ratio Ti:Pd of 1:1, in the coating layer is 50 mol % or higher.

3. The device according to claim 1, wherein
a voltage is detected per alkali storage battery cell or per module including plural alkali storage battery cells.

4. The device according to claim 3, wherein
in a case where a voltage of the alkali storage battery cell or the module is a threshold or higher, discharging of the alkali storage battery cell or the module is continued, and
in a case where the voltage of the alkali storage battery cell or the module is lower than the threshold, discharging of the alkali storage battery cell or the module having a voltage lower than the threshold is stopped.

5. The device according to claim 4, wherein
a circuit is changed such that a current flows through a bypass circuit that bypasses alkali storage battery cells having a voltage lower than the threshold or modules having a voltage lower than the threshold.

6. The device according to claim 5, wherein
the controller is configured to determine whether or not an output request from a control device for controlling driving of an automobile can be satisfied by discharging alkali storage battery cells other than alkali storage battery cells, which are disconnected from the circuit, or discharging modules other than modules including alkali storage battery cells, which are disconnected from the circuit, without applying a load equal to or higher than a threshold to the alkali storage battery cells or the modules, and
the controller is configured to determine whether an output value is set to be equal to or lower than a value requested from the control device for controlling the driving of the automobile by determining whether or not the output request from the control device for controlling driving of the automobile can be satisfied.

7. The device according to claim 6, wherein
based on the number of alkali storage battery cells which are disconnected from the circuit or the number of modules including alkali storage battery cells which are disconnected from the circuit, the controller is configured to determine whether or not the output request from the control device for controlling driving of the automobile can be satisfied by discharging alkali storage battery cells other than alkali storage battery cells, which are disconnected from the circuit, or discharging modules other than modules including alkali storage battery cells, which are disconnected from the circuit, without applying a load equal to or higher than a predetermined value to the alkali storage battery cells or the module.
